(19) United States
(12) Patent Application Publication
(10) Pub. No.: US 2005/0250049 A1
(43) Pub. Date: Nov. 10, 2005

(54) Bi-wavelength optical intensity modulators using materials with saturable absorptions

(76) Inventors: Chen-Chia Wang, Newark, DE (US); Sudhir Trivedi, Baltimore, MD (US)

Correspondence Address: Max Stul Oppenheimer, P. O. Box 50, Stevenson, MD, 21153, US

(21) Appl. No.: 11/032,563

(22) Filed: Jan. 10, 2005

Related U.S. Application Data
(60) Provisional application No. 60/535,165, filed on Jan. 8, 2004.

(51) Int. Cl. G03C 5/00

(52) U.S. Cl. 430/311

(57) ABSTRACT

Device and method for exposing photoresists on semiconductor wafers without using physical masks while improving significantly the time- and cost-efficiencies for the manufacturing of integrated-circuit chips. Two electromagnetic sources of different wavelengths are used as the light sources, with the one having longer wavelength functioning as the control light beam while the one with an appropriately shorter wavelength is used to eventually expose the photoresists on semiconductor wafers. Images of the desired circuit patterns are first imposed onto the longer wavelength control light beam using, for example but not limited to, laser diode arrays, light emitting diode arrays, and devices similar to liquid crystal displays. The image-carrying control light beam interacts inside the bi-wavelength saturable absorber with the short-wavelength exposure light beam which carries initially a uniform intensity profile. The bi-wavelength saturable absorber transfers the images carried by the control light beam to the exposure light beam upon its exit from the bi-wavelength saturable absorber. The exposure light beam can then be used to expose photoresists without using any physical masks. The invention eliminates the prohibitively high front end costs associated with the design and production of large physical masks with fine spatial features sought for by the state-of-the-art integrated-circuit manufacturing processes. The invention, when combined with appropriate light sources, also improves the throughput rates for the fabrication of integrated-circuit chips by orders of magnitude, further enhancing the economic impacts.

This application is entitled to and claims the benefit of U.S. Provisional Application of Chen-Chia WANG and Sudhir TRIVEDI for Bi-Wavelength Optical Intensity Modulators using Materials with Saturable Absorptions, filed on Jan. 8, 2004 and assigned Ser. No. 60/535,165.

### FIELD AND BACKGROUND OF THE INVENTION

1. Field of the Invention

This invention relates to the field of modulating the intensity profile of one laser beam using another laser beam whose wavelength is different, and more particular to the optically programmable intensity profile modulations on the short wavelength light beam using the longer wavelength light beam as the controller.

2. Background Information

The invention described and claimed herein comprises a novel and significantly efficient, economic-wise, method and device for optically transferring the desired intensity patterns from a longer wavelength control light beam onto a short wavelength light beam that can be used, but not limited to, to expose the photoresist films on semiconductor wafers during the integrated-circuit manufacturing processes, leading to improved and finer resolutions in the resultant circuit patterns while eliminating the use of physical masks.

Lithography is a standard procedure for imprinting the desired circuit patterns onto semiconductor wafers that in the end can be fabricated into various kinds of integrated-circuit chips with versatile functions. The state-of-the-art approach for lithography involves photolithography in which light beams of certain wavelength are used, in combination with physical masks, to expose photoresist layers that are deposited on the semiconductor wafers prior to the stated exposure by the exposure light beams. The said physical masks bear the positive or negative images of the desired circuit patterns to be imprinted on the semiconductor wafers. Upon exposure by the stated exposure light beams, the photoresist layers are further developed and processed, mostly chemically, leading to patterns in the photoresist layer closely resembling the circuit patterns carried by the physical masks. The resultant semiconductor wafer can then undergo further processing to the desired specifications through, for example but not limited to, doping of proper dopant species and dosage, as well as the coating of metallic layers.

The state-of-the-art photolithographic approaches for semiconductor integrated-circuit manufacturing have the advantage of being applicable in mass-production environments, provided that correct and reliable physical masks are readily available. This advantage stems from the fact that physical masks, assuming their availability, can be used to time-efficiently fabricate mass quantities of identical, standardized integrated circuits. This compares favorably to great extent with other state-of-the-art techniques like e-beam lithography which can provide much finer spatial resolution without requiring physical masks but at the challenging expense of lengthy exposure times.

There are several disadvantages associated with the said conventional photolithographic techniques, including but not limited to, the prohibitively high production costs and the lengthy manufacturing lead time of the physical masks, particularly as the spatial features are reduced for the state-of-the-art integrated circuit. Another disadvantage is the highly time consuming calibration and trial run processes required before reliable and producible physical masks can be developed and used in the mass production processes for semiconductor integrated circuits. As the characteristic physical dimensions of integrated circuits shrink due to the anticipated gain in computing efficiency and power as well as the increase in semiconductor wafer sizes, masks with finer features are required which inherently increases the production costs and consumes long period of time for their productions. Such front-end costs become prohibitive especially for today's application-specific integrated circuits (ASIC) which command versatile functions and yet the production quantity is generally quite limited. These problems are further compounded by the fact that multiple runs in the design and development of physical masks are generally required before the final and correct configuration of the physical masks can be found which can be used to produce reliably the integrated circuit chips with the desired functionality and high manufacturing yields.

### SUMMARY OF THE INVENTION

It is thus desirable to develop and achieve technologies capable of producing the desired fine spatial features in the integrated circuits without using physical masks while providing the mass production capability offered by the state-of-the-art photolithographic approaches. Such a technology will offer significant cost savings as well as improve dramatically the production efficiency because, for example, the desired mask patterns can be manipulated and adjusted using either electrical or optical means which allow near-instantaneous operation as opposed to waiting idly while the physical masks are being re-designed, developed, and produced.

### BRIEF DESCRIPTION OF THE DRAWINGS

FIG. 1 shows a schematic of one embodiment of the invention.

FIG. 2 shows the energy diagram of the ground and excited states in a typical DX-defect containing material (AlGaAs:Te in this case)

FIG. 3 shows a schematic of a second embodiment of the invention.

### DESCRIPTION OF THE PREFERRED EMBODIMENT

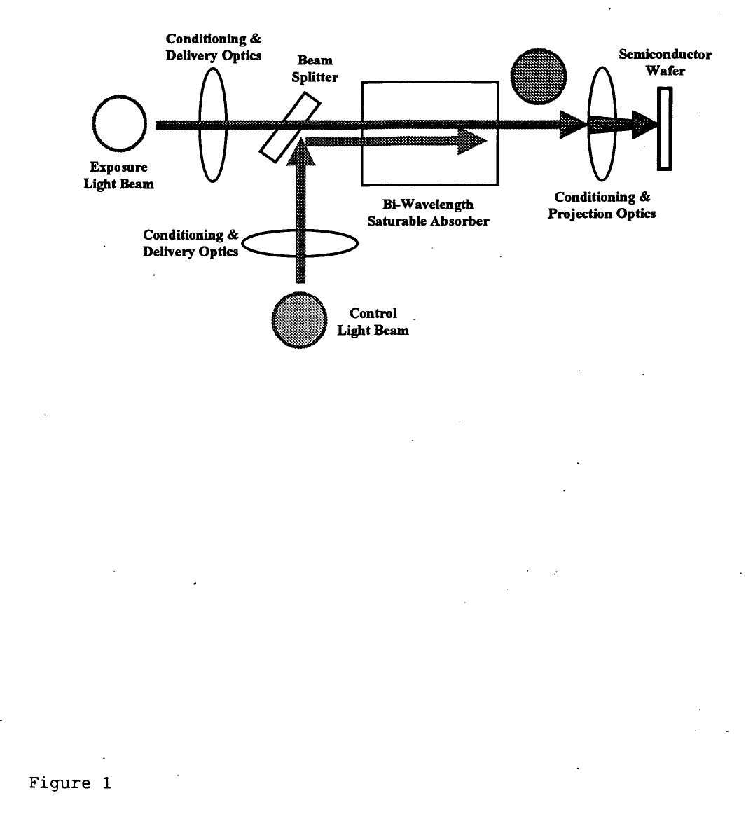

One embodiment of this invention is shown in FIG. 1 which consists of two light beams, herein named as the control light beam and the exposure light beam. Further comprising of the embodiment are certain optics for conditioning and delivering the light beams as well as a bi-wavelength saturable absorber based on, but not limited to, certain classes of optical materials that can be grown and processed.

In the invention, the control light beam shall have the wavelength that is relatively longer than that of the exposure light beam. For example, the wavelength range of the control light beam can be within the visible spectrum while the exposure light beam can have the wavelength that is within the deep ultraviolet (DUV) range. The selection of particular wavelength values for the control and exposure light beams are dominated by the inter-play of the following factors: commercial availability, interactions with the bi-wavelength saturable absorbers, sensitivity to the photoresists, and the sizes of the spatial feature of the integrated-circuit chips to be fabricated. To be specific, the wavelengths of the control and exposure light beams must be within the spectrum in which the bi-wavelength saturable absorber is responsive to. The wavelength of the -exposure light beam must be quite short so as to meet the advancing and stringent requirements on fabricating integrated circuits with finer spatial features. The selection of the control light beam wavelength, while being more flexible, depends on the economic availability of light sources within the, for example but not limited to, visible spectrum, as well as the available power levels. The control light beam should possess sufficiently high optical power levels and power densities so as to ensure successful operation of the bi-wavelength saturable absorber and high-fidelity circuit pattern transfers from the beam profile of the control light beam onto that of the exposure light beam.

In the invention, the desired circuit patterns shall be imposed onto the cross-sectional beam profile of the control light beam.

This can be achieved by using, for example but not limited to, light sources comprising of laser diode arrays or arrays of light-emitting diodes. Other means also include the deployment of external light sources in combination with, for example but not limited to, micro-electro-mechanical (MEM) mirror arrays, or liquid crystal displays found in modern flat-panel computer or TV displays/monitors. These image modulators are to have arrays of pixels with sufficiently small dimensions so as to facilitate the image transfers from the control light beam onto the exposure light beam.

Either the positive or the negative image of the desired circuit patterns shall be imposed onto the control light beam intensity profile, depending on the requirements of the integrated-circuit manufacturing processes.

In the invention, the generation of the desired circuit patterns, either the positive or negative images of them, can be achieved by, for example but not limited to, using high speed computers capable of time-efficiently produce the desired circuit patterns and control the modulation circuitry used to impose those images onto the control light beam.

In the invention, the exposure light beam is to be generated by a light source with the appropriately short wavelength. It is further conditioned and then delivered, with a preferably uniform intensity profile and sufficient power strength, onto the beam splitter shown in FIG. 1 where it is combined with the image-carrying, longer wavelength control light beam with sufficient precision in matching the positions of their cross-sectional profiles. The pair of light beams exiting from the beam splitter then propagate, co-linearly, into the bi-wavelength saturable absorber where they interact with the bi-wavelength saturable absorber. With the appropriate physical dimensions, species of dopants and their densities, the bi-wavelength saturable absorber shall transfer, at its exit plane, an exposure light beam whose cross-sectional intensity profile is identical to that of the longer wavelength control light beam prior to its entrance into the bi-wavelength saturable absorber. The cross-sectional area of the bi-wavelength saturable absorber is to be greater than the laser beam spot size so as to accommodate the interacting laser beams completely. Sufficient thickness of the bi-wavelength saturable absorber is to be required so as to achieve 100 percent contrast ratio in the exited exposure beam intensity profile, if required by the desired circuit patterns.

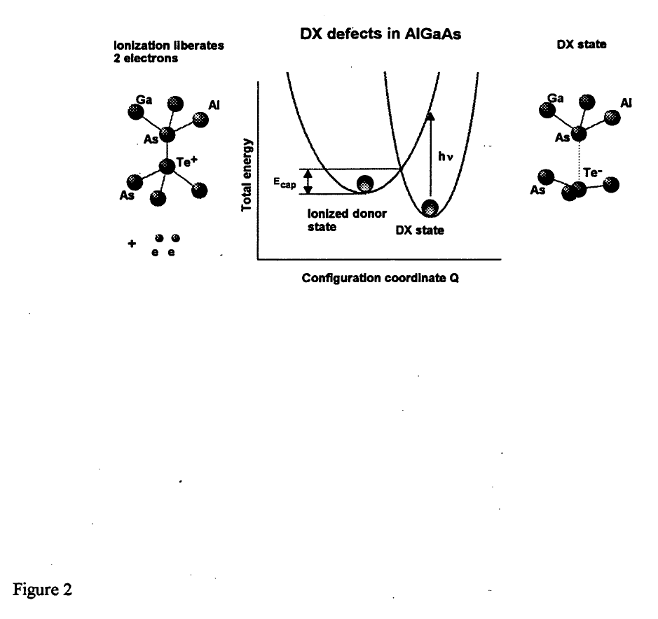

In the invention, the bi-wavelength saturable absorber is based, for example but not limited to, on a class of optical materials that exhibit the so-called DX effects. In such an optical material, by doping appropriate species of dopants into the host material, for example, gallium (Ga) in cadmium fluoride (CdF₂), the so-called DX defects can be created in the grown materials. Generally speaking, these DX defects create lattice distortions which can be relaxed by the incident photons with sufficiently high energy. As shown in FIG. 2, the presence of DX defects thus generates two energy levels for electrons, i.e., the ground state and the excited state (ionized donor state or meta-stable state). The ground state and the excited states are separated by an energy barrier characteristic of the interaction between the dopant and the host material. Upon the absorption of the incident photons, electrons can be excited from the ground state onto the excited state if the photon has sufficiently high energy. On the other hand, if electrons residing in the excited state can acquire sufficient energy, for example, through thermal heating or electric field acceleration, they can overcome the energy barrier and return to the ground state and the DX material becomes refreshed and ready for the writing of new images. The distribution of electrons between the ground and excited states can be thus easily manipulated via, for example, temperature control on the DX material or the applied bias electric field.

One unique characteristic of the DX materials, shown in FIG. 2, is the fact that, instead of discrete energy levels, there exist bands of energy levels that allow the absorption of photons within a wide range of spectrum, for example, from deep ultraviolet to visible. Because the total amount of DX absorption centers are limited by the introduced dopants, this characteristic broadband absorption allows the modulation of the absorption of short wavelength exposure light beam by the longer wavelength control light beam, which is exploited by the invention. As an example, the absorption of DUV exposure light beam by the bi-wavelength saturable absorber can be readily modulated by the introduction or elimination of the control light beam whose wavelength is located in the visible spectrum. To one extreme, if all the DX absorption centers are bleached out by the visible control light beam, the bi-wavelength saturable absorber becomes transparent to DUV light beam. One the other hand, if the DX absorption centers are left intact by the absence of the visible light beam, the bi-wavelength saturable absorber can then absorb completely the DUV light beam, provided that sufficient interaction length is available. This unique characteristic of the bi-wavelength saturable absorber is the foundation for their application to mask-less photolithography pursued by the invention. Note that the modulation on the absorption of long wavelength light beam by a shorter wavelength light beam is also feasible.

Referring to the embodiment shown in FIG. 1, the operation principle of the invention can be further understood by considering the specific example in which the longer wavelength control light beam is visible while the short wavelength exposure light beam is DUV. In operation, the desired circuit patterns are first imposed onto the visible control light beam by, for example but not limited to, liquid crystal based display devices. The image-carrying visible control light beam is then combined with the un-modulated, uniform-intensity DUV exposure light beam using a beam splitter. The control and exposure light beams then co-propagate through the bi-wavelength saturable absorber that has a sufficient thickness and doping density. If a bright spot in the exposure light beam is desired upon its exit from the bi-wavelength saturable absorber, it is necessary to make the bi-wavelength saturable absorber transparent to the DUV exposure light beam along its path. This can be achieved by correspondingly bleaching out all of the DX absorption centers or states along that particular path and hence the exposure light beam would not be attenuated at all, resulting in a bright spot at the exit plane of the bi-wavelength saturable absorber. Such bleaching can be achieved by the presence of the visible control light beam with appropriate power density levels. On the other hand, if a dark spot in the exposure beam profile is required, it becomes necessary that the bi-wavelength saturable absorber absorbs all of the short wavelength exposure light photons along that particular path of exposure light beam propagation. This can be achieved if the DX absorption centers or states are available along that particular path within the bi-wavelength saturable absorber which in turn can be achieved by turning off the visible control light beam along that very same path of propagation. As a result, the desired circuit patterns can be faithfully transferred from the long-wavelength visible control light beam directly onto the short-wavelength DUV exposure light beam, assuming the thickness and DX state density of the bi-wavelength saturable absorber is sufficient.

The required interaction length over which the control, exposure light beams, and the bi-wavelength saturable absorber interact depends on the beam characteristics of the exposure light beam, i.e., its wavelength, pulse energy, duration, and beam diameter. The required interaction length and the effective DX doping density then further determine the thickness of the bi-wavelength saturable absorber required. Estimates on the required thickness, L_{eff}, of the bi-wavelength saturable absorber have been calculated based on the following DUV beam characteristics that are typical in state-of-the-art semiconductor manufacturing processes: 193 nm wavelength, 10 ns pulse width, 10 mj pulse energy, and 1-cm DUV beam diameter.
L_{eff}=0.98 mm, N_{D}=10¹⁷ cm⁻³
L_{eff}=100 μm, N_{D}10¹⁸ cm⁻³ (1)

It can be seen from eqn(1) that, as the DX doping density is increased, the required thickness for the bi-wavelength saturable absorber is reduced. This is due to the fact that more DX absorption centers are available along a given path through the bi-wavelength saturable absorber as the doping density is increased and hence the minimal thickness required for 100% DUV beam absorption is correspondingly reduced. Also note from eqn(1) that the thickness of the bi-wavelength saturable absorber can be smaller than 100 gm based on the reported doping density of N_{D}=2.7×10¹⁸ cm⁻³. Even though hurdles in mechanical packaging and handling is foreseen, such small thickness for the bi-wavelength saturable absorber has the significant advantages of ease of thermal manipulation and stabilization, as well as the elimination of optical birefringence issues at the DUV spectrum.

Different circuit patterns are needed as the mask-less scanner scans over different areas of the semiconductor wafer during the manufacturing processes. This requires the refreshment of the bi-wavelength saturable absorbers and the subsequent loading or writing of new circuit patterns and images. Refreshment of the bi-wavelength saturable absorbers involves flushing out the electrons residing in the excited/meta-stable state and force them back into the ground state. Upon their relaxation back into the ground state, the bi-wavelength saturable absorber becomes ready to accept the writing of new images. In order to force the excited electrons relax back to the ground state, they must acquire sufficient energy to overcome the recombination energy barrier (E_{cap}, see FIG. 2). Such energy can be supplied by, for example, raising the temperature of or applying a bias electric field to the bi-wavelength saturable absorber. Depending on the host materials and the dopant, the recombination barriers can range from 0.1 eV to 0.7 eV with the corresponding refreshment times at room temperature stemming from a few seconds to sub-microseconds. With the low energy barrier of 0.1 eV, refreshment of the bi-wavelength saturable absorber can be achieved within sub-microsecond scale and thus affords the resultant mask-less scanner the exceptional-capability of exposing photoresists at rates in excess of one hundred-fold greater than existing state-of-the-art technologies, provided exposure light sources with correspondingly high pulse repetition rates are available. The throughput of the mask-less photolithographic technology of the invention can thus be correspondingly increased by a factor of 100 greater than existing state-of-the-art semiconductor manufacturing capabilities. As an example, the bi-wavelength saturable absorbers based on indium (In) doped cadmium fluoride (CdF₂) exhibit response times shorter than 1 μs at room temperature (300° K.) . In the room temperature operation of the invention, one can use the CdF₂:In based bi-wavelength saturable absorber to exploit the ultra-fast image refreshment rates whose upper limit is determined by the response time of the bi-wavelength saturable absorber. With a response time of 1 μs, the mask-less photolithographic technology of the invention can offer refreshment rates in excess of 100 kHz. Note that no electric field acceleration is required for refreshing the bi-wavelength saturable absorber when operated in this mode. In addition to the deployment of light sources with sufficiently high pulse repetition rates, these light sources shall have stronger optical power densities because the excited DX states relax back towards the ground state at a much faster rate when operating at room temperature as compared to lower operating temperatures.

In the invention, the bi-wavelength saturable absorber shall generate thermal heat due to the absorption of photons of the control light beam, the exposure light beam, or both. Such waste heat must be removed efficiently to ensure stable operation characteristics of the bi-wavelength saturable absorbers. The heat removal can be achieved by attaching the saturable absorber to heat sinks like, for example but not limited to, thermal electric coolers. For the purposes of ease in mechanical handling and efficient removal of thermal heat, bi-wavelength saturable absorbers with small thickness can be mounted on substrate materials that are transparent to the light beams being used in the invention. They can also be sandwiched in between those transparent optical materials. Special arrangements in the orientation of the transparent optical substrates can be deployed to minimize optical birefringence effects.

Gray-scale operation for exposing the photoresists is also allowed by the invention. This is achieved by manipulating the optical intensity of the longer-wavelength control light beam to levels in between complete darkness and that corresponding to 100% bleach-out of the bi-wavelength saturable absorber. Such intensity manipulation of the control light beam allows partial bleaching of the bi-wavelength saturable absorber and hence the short wavelength exposure light beam, upon its exit from the bi-wavelength saturable absorber, shall have intensity levels in between complete darkness and that of unperturbed, 100% transmission. Hence gray-scale operation is achieved by the invention.

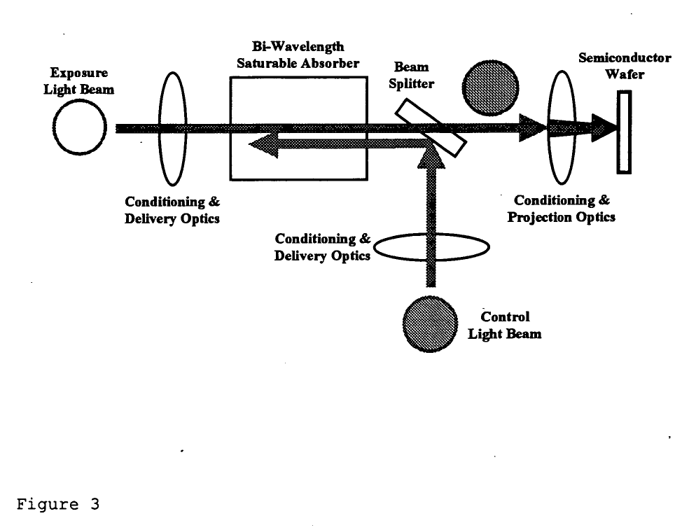

Another embodiment of the invention is shown in FIG. 3. The longer wavelength control light beam in this embodiment is to be imposed with the desired circuit patterns using the same means described in the previous embodiment shown in FIG. 1. It is further deflected by the beam splitter before entering the bi-wavelength saturable absorber and counter-propagates with the short-wavelength exposure light beam. This embodiment has the advantage that the longer wavelength control light beam is diverted away from the photoresist-coated semiconductor wafers and hence eliminates the complication of undesired exposure of the photoresists by the longer wavelength control light beam which deteriorates the resolution of the exposed circuit patterns. This embodiment is made possible due to the fact that the depletion or bleach-out of the DX absorption centers/states can be achieved by the presence of longer wavelength control light beam with appropriate. intensity levels. The direction of propagation of the control light beam is irrelevant, as long as it is on the same path as that of the short wavelength exposure light beam.

The typical procedures for exposing photoresists on semiconductor wafers to the desired patterns and without using physical masks as claimed by the invention can be described as follows: a light source with a longer wavelength is to be used as the control light beam. Another light beam, with a shorter wavelength than that of the control light beam, is to be used as the exposure light beam for exposing the photoresist layers on semiconductor wafers during the manufacturing of integrated-circuit chips. A bi-wavelength saturable absorber, which is to have sufficient thickness and appropriate dopant species and density, acts as the agent for transferring the images carried by the longer wavelength control light beam onto the shorter wavelength exposure light beam. The desired circuit patterns are imposed onto the longer wavelength control light beam using, for example but not limited to, devices similar to liquid crystal displays. The desired image patterns can be calculated and controlled by computers with sufficiently high computing power and communicating bandwidth for controlling the liquid crystal displays. The image-carrying control light beam enters the bi-wavelength saturable absorber, either co-propagating or counter-propagating, with the shorter wavelength exposure light beam. The bi-wavelength saturable absorber, in the presence of appropriate dopants, is capable of transferring the images carried by the control light beam onto the exposure light beam, with either 100% fidelity or, if desired, gray-scale operations. Upon exiting the bi-wavelength saturable absorber, the image-carrying short wavelength exposure light beam can be further conditioned and projected onto the semiconductor wafers and expose the photoresists.

The foregoing examples of the use of the invention show that the system and methodology of the invention are adaptable to the exposure of photoresists on semiconductor wafers without using physical masks while improving the manufacturing throughput and efficiency to-great extent.

While a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. Thus, the invention is not limited to the specific embodiment described herein, but is defined by the appended claims.

1. A process for maskless photolithographic creation of a desired integrated circuit pattern, comprising:
providing an optical material whose optical absorption coefficient at a first, shorter wavelength (λ_{S}) exposure light beam, can be modified by a second, longer wavelength (λ_{L}) control light beam,
providing means for adjusting the intensity patterns of the control light beam,
and adjusting the intensity patterns of the control light beam so as to control the amount of passage of the exposure light beam through the optical material so that said intensity patterns create the desired integrated circuit pattern.

2. A process as in claim 1 wherein said means for adjusting the intensity patterns of the control light beam comprise laser diode arrays or light emitting diode arrays with appropriate sizes and emitted light intensities, or micro-electro-mechanical mirror arrays or liquid crystal displays with a light source of the appropriate wavelength and intensity, under control of a computer program.

3. A device for maskless photolithographic creation of a desired integrated circuit pattern, comprising:
an optical material whose optical absorption coefficient at a first, shorter wavelength (λ_{S}) exposure light beam, can be modified by a second, longer wavelength (λ_{L}), control light beam,
means for adjusting the intensity patterns of the control light beam,
and means for adjusting the intensity patterns of the control light beam so as to control the amount of passage of the exposure light beam through the optical material so that said intensity patterns create the desired integrated circuit pattern.

4. A device as in claim 3 wherein said means for adjusting the intensity patterns of the control light beam comprise laser diode arrays or light emitting diode arrays with appropriate sizes and emitted light intensities, or micro-electro-mechanical mirror arrays or liquid crystal displays with a light source of the appropriate wavelength and intensity, under control of a computer program.

5. A device as in claim 3 or claim 4 wherein said exposure light beam is deep ultraviolet in wavelength and said control light beam is blue or green in wavelength.

6-9. (canceled)

10. A process for maskless photolithographic creation of a desired integrated circuit pattern, comprising
providing an optical material whose optical absorption coefficient at a first wavelength (λ₁) exposure light beam, is modified by a second, different wavelength (λ₁), control light beam,
providing means for adjusting the intensity patterns of the control light beam,
and adjusting the intensity patterns of the control light beam so as to control the amount of passage of the exposure light beam trough the optical material so that said intensity patterns create the desired integrated circuit pattern.

11. A process as in claim 10 wherein said means for adjusting the intensity patterns of the control light beam comprise laser diode or light emitting diode arrays with appropriate sizes and emitted light intensities, under control of a computer program.

12. A device for maskless photolithographic creation of a desired integrated circuit pattern, comprising
an optical material whose optical absorption coefficient at a first wavelength (λ₁) exposure light beam, can be modified by a second, different wavelength (λ₂), control light beam,
and means for adjusting the intensity patterns of the control light beam so as to control the amount of passage of the exposure light beam through the optical material so that said intensity patterns create the desired integrated circuit pattern.
